(19) United States
(12) Patent Application Publication
(10) Pub. No.: US 2006/0147678 A1
(43) Pub. Date: Jul. 6, 2006

(54) Touch sensitive interface

(76) Inventors: George Marmaropoulos, Yorktown Heights, NY (US); Giang Vu, New York, NY (US); Katharine Pulford, Hackney (GB)

Correspondence Address: PHILIPS INTELLECTUAL PROPERTY & STANDARDS, P.O. BOX 3001, BRIARCLIFF MANOR, NY, 10510, US

(21) Appl. No.: 10/560,712

(22) PCT Filed: Jun. 28, 2004
(86) PCT No.: PCT/IB04/51032

§ 371 Date: Dec. 15, 2005

(30) Foreign Application Priority Data
Jun. 30, 2003 (US) 60483776

(51) Int. Cl. B32B 3/00

(52) U.S. Cl. 428/172

(57) ABSTRACT

There is provided a flexible, lightweight high-performance touch sensitive interface or textile construction (1) having one or more touch sensitive switches (10) cooperative with a variety of different textiles including those commonly used in upholsteries and/or garments (65), as well as various electronic devices/systems (40) without compromising the inherent characteristics or properties associated with such textiles. The one or more touch sensitive switches (10) have a three-dimensional recess (20) and one or more conductive fibers (35) having an electromagnetic field (37) associated therewith. The one or more conductive fibers (35) can be formed into a conductive coil (30).

The present invention relates to textile electronics. More particularly, the present invention relates to an interface having one or more touch activated switches preferably integrated into a flexible textile construction. The touch sensitive interface is preferably operatively connectable with a variety of electronic devices/systems.

The use of electronics in various manufactured materials is well known; see for example, U.S. Pat. Nos. 6,360,615 B1, 6,210,771 B1, and 5,371,326; U.S. Patent Application Publication No. 2002/0135457 A1; PCT International Patent Publication Nos. WO 02/055923 A1 and WO 02/32665 A1; and/or UK Patent Application No. GB 2 373 863. Devices such as conductive traces, bio-sensors, electrodes, computers, electronic circuits and the like have all been incorporated into textiles. As the benefits associated with the various types and/or configurations of textile electronics become more apparent, the desirability and need for simple, effective and efficient, as well as intuitive user interface solutions becomes more apparent. Hence, there is a need for an input device or interface that is complementary to the various electronic devices/systems associated with the different textile electronics and/or the materials accommodating such electronics.

It is an object of the present invention to provide an interface suitable to address the above-identified need for simple, effective and efficient, as well as intuitive user interface solutions.

It is another object of the present invention to provide such an interface that has a flexible textile construction.

It is another object of the present invention to provide such an interface with one or more switches having an electromagnetic field.

It is another object of the present invention to provide such an interface that is capable of detecting variations in an electromagnetic field associated with one or more switches.

It is another object of the present invention to provide such an interface that is capable of interpreting variations an electromagnetic field associated with one or more switches.

It is another object of the present invention to provide such an interface being cooperative with a variety of textiles including those commonly used in garments/upholstery without compromising the innate characteristics/properties of such textiles, as well as being operatively connectable with various electronic devices/systems.

It is another object of the present invention to provide such an interface for accomplishing a variety of different electronic operations or functions.

These and other objects and advantages of the present invention are achieved by an interface having one or more switches associated with a textile construction. The one or more switches having at least one well or recess and at least one conductive coil. The conductive coil having an electromagnetic field associated therewith that can be influenced by an interaction with the recess. The influence on the electromagnetic field via the interaction with the recess causes a detectable interference. This detectable interference may be detected via a circuit or detector, which in turn, can actuate an associated electronic function/operation. Thus, the one or more switches are touch-sensitive and facilitate accomplishing one or more relatively complicated electronic functions/operations. Also, the one or more touch-sensitive switches can be made impermeable should waterproofing and/or insulating be required for a particular interface solution.

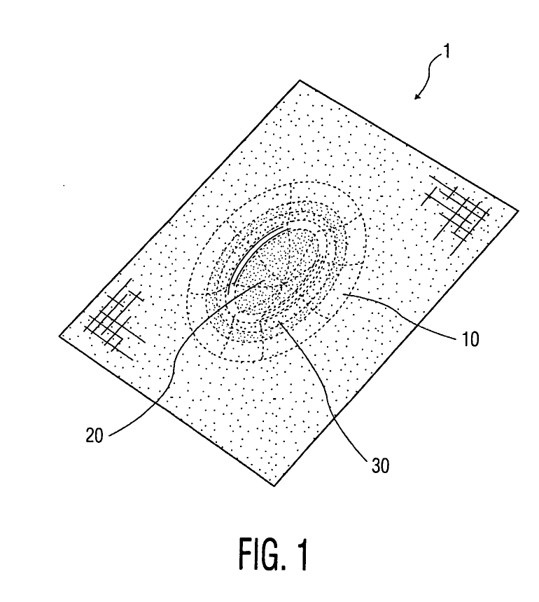

FIG. 1 is a perspective view of a touch sensitive switch in accordance with an illustrative embodiment of the present invention;

FIG. 2 is a plan section view of the touch sensitive switch of FIG. 1;

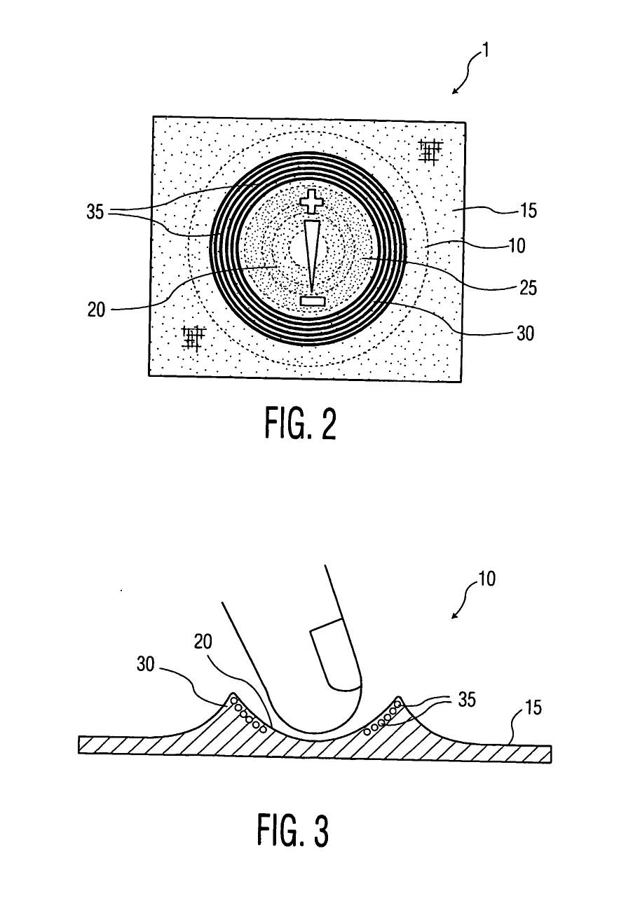

FIG. 3 is a side section view of the touch sensitive switch of FIG. 1 showing an interaction therewith;

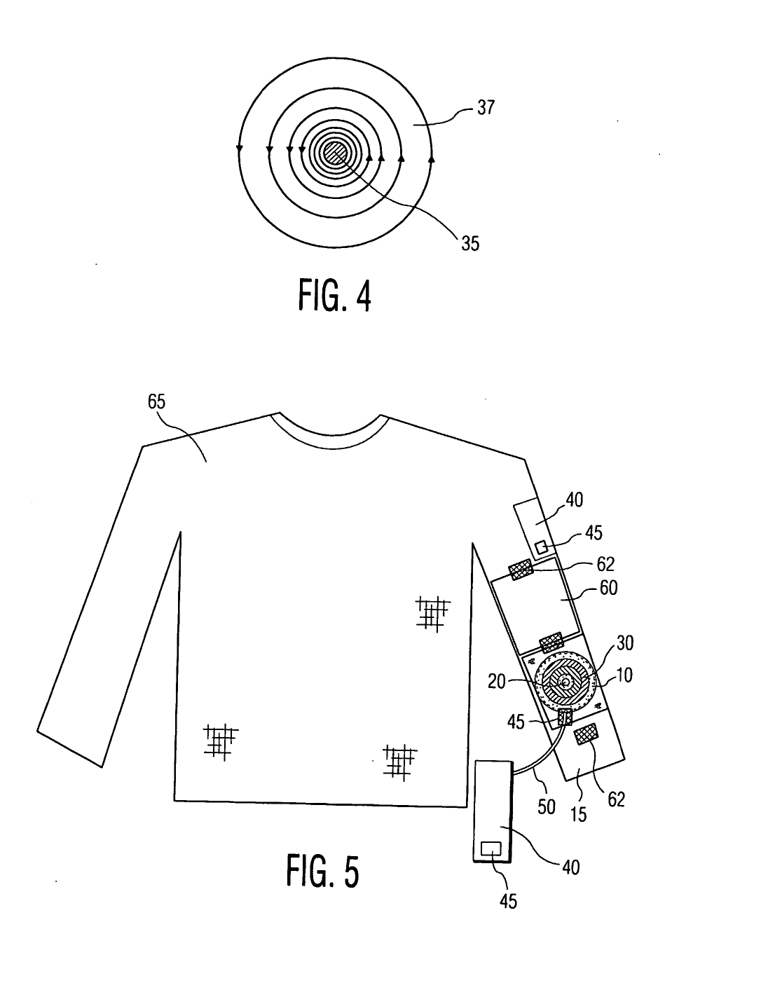

FIG. 4 is an end section view of a magnetic field of a conductive fiber in accordance with an illustrative embodiment of the present invention; and

FIG. 5 is a front view of a garment incorporating an interface having the touch sensitive switch of FIG. 1.

Referring to the drawings and, in particular, FIG. 1, a textile mesh or construction in accordance with an illustrative embodiment of the present invention is shown and generally represented by reference numeral 1. Preferably, textile construction 1 is in the form of an interface having one or more switches 10 with a well or recess 20 and a conductive coil 30.

The one or more switches 10 preferably can be formed into a multitude of different patterns facilitating a variety of different applications in use. The one or more switches 10 preferably can cooperate with a variety of different electronic devices, such as for example, various textile electronics, biosensors, medical instruments, or health therapy equipment. The one or more switches 10 preferably may also operate independently to accomplish a variety of different electronic operations. The one or more switches 10 can be fashioned from any combination of natural or manmade materials and/or elements appropriate to form a soft touch sensitive switch capable of providing an intuitive user interface and/or control. Moreover, the one or more switches 10 can be any desired shape, size or configuration necessary to facilitate various different electronic operations, functions and/or uses.

The one or more switches 10 preferably are operative to facilitate electrical communication between various electronic devices, systems and/or power sources 40, such as for example those shown in FIG. 5, via the textile construction and/or interface 1. A connector 50 such as for example that shown in FIG. 5, preferably can also be used to provide a medium for electrical communication between and/or among various electronic devices, systems, and/or power sources 40 and the textile construction and/or interface 1. The connector 50 can have any configuration suitable to provide the effective means of electrical communication.

Referring to FIGS. 2 and 3, the well or recess 20 can be formed into any of a multitude of different shapes, sizes, and/or configurations suitable for accommodating a variety of different intuitive user interface applications. However, it is preferable that the recess 20 be annular and three dimensional. The recess 20 is preferably fashioned to envelop or enfold the conductive coil 30. The recess 20 can also be fashioned from any of a variety of conductive, non-conductive and/or semi-conductive materials, such as for example, flexible metal coated material including woven, non-wovens, and/or knits, filaments, foils, and yarns, conductive polymer coated material, conductive graphitized material, conductive gel coated material, cotton, lycra, spandex, neoprene, polyester, rubber extruded material, polypyrrole/lycra material, polypyrrole/nylon material, polypyrrole/polyester material, any conjugated polymer, ion-implanted polymers or any combination of the same. Preferably, the recess 20 is formed via any method known for providing such an annular type construction. Alternatively, the recess 20 can be formed via an injection process in which the recess 20 is injected molded from a rubber or similar material directly onto a surface 15 of a textile.

The conductive coil 30, like the recess 20 can be formed into any of a multitude of different shapes, sizes, and/or configurations suitable for accommodating a variety of different intuitive user interface applications. However, as with the recess 20, it is preferable for the conductive coil 30 to be annular and three dimensional. The conductive coil 30 is preferably fashioned from one or more conductive fibers 35 suitable for generating or creating an electromagnetic field 37 such as that shown in FIG. 4. It is noted however, that the conductive coil 30 is not limited to this fiber-type construction and that other forms and/or construction types suitable for accomplishing the various objects of the present invention may also be used. In any case, the one or more conductive fibers 35 and/or the conductive coil 30 preferably have and/or generate an electromagnetic field 37 thereabout such that any interaction with the electromagnetic field 37 can be detected via a circuit or a detector. It is noted that the one or more conductive fibers 35 and/or the conductive coil 30 can be fashioned from any conductive and/or semi-conductive material suitable for accomplishing the objects of the present invention, such materials might include for example, flexible metal coated material including woven, non-wovens, and/or knits, filaments, foils, and yarns, conductive polymer coated fiber/material, conductive graphitized material, and/or conductive gel coated material.

Having described some of the preferred characteristics of an illustrative embodiment, the one or more switches 10 preferably operate by detecting interferences in the electromagnetic field 37 of the conductive coil 30 and/or the one or more conductive fibers 35. By way of illustration, a user can interact with the one or more switches 10 using his/her finger, for example, to cause interference in the electromagnetic field 37. This interference can be directly or indirectly discerned and/or detected via an electronic circuit or detector 45, which in turn can either directly or indirectly actuate one or more associated electronic functions/operations.

The method or process of forming a touch sensitive user interface preferably includes fashioning a three dimensional well or recess 20 from or onto a textile mesh or construction 1 via any known method for accomplishing such construction (e.g., sewing, knitting and/or weaving). Then, one or more conductive fibers 35 are preferably inlayed and/or incorporated into the recess 20 via any known method for accomplishing such a task. This inlaying process can be accomplished during and/or after the formation of the recess 20. Once the one or more conductive fibers 35 have been incorporated or inlayed into the recess 20 to form a conductive coil 30, the recess 20 and the one or more conductive fibers 35 can be heat molded to improve the strength and/or durability thereof.

Interface graphics 25 can also be patterned or printed on the interface textile construction 1. Preferably, the interface graphics 25 are suitable for easing user interpretation of various functions/operations associated with various types of wearable electronics and like devices. It is noted that the interface graphics 25 can be either part of and/or integral with an abstract or decorative pattern associated with a textile. It is further noted that the textile construction 1 can have a cover 60, such as for example, a Velcro arrangement 62 such as that shown in FIG. 5. Other types of cover arrangements sufficient to selectively cover and/or protect the one or more switches 10 may also be used. Alternatively, or in addition, the one or more switches 10 can be made impermeable to accomplish a desirable waterproofing and/or insulating effect.

Thus, the interface or textile construction 1 preferably has properties suitable to provide sufficient flexibility and durability to withstand the stresses associated with the manufacture and the handling thereof. Thus, the interface or textile construction 1 is preferably a highly flexible/resilient, lightweight high-performance intuitive user interface cooperative with various different textile electronics that can be integral with and/or connected to the different textiles including upholstery and/or garment textiles 65 without compromising the innate characteristics of such textiles.

The present invention having been thus described with particular reference to the preferred forms thereof, it will be obvious that various changes and modifications may be made therein without departing from the spirit of the present invention as defined herein.

What is claimed is:

1. A touch sensitive interface, comprising:
a textile construction (1) having a recess (20), and
a conductive coil (30) with an electromagnetic field (37) associated with said recess (20).

2. The touch sensitive interface of claim 1, wherein said recess (20) is integral with said textile construction (1).

3. The touch sensitive interface of claim 1, wherein said recess (20) is injected molded onto said textile construction (1).

4. The touch sensitive interface of claim 1, wherein said recess (20) is three-dimensional.

5. The touch sensitive interface of claim 1, wherein said conductive coil (30) is fashioned from one or more conductive fibers (35).

6. The touch sensitive interface of claim 5, wherein at least some of said one or more conductive fibers (35) generate said electromagnetic field (37).

7. The touch sensitive interface of claim 6, wherein said electromagnetic field (37) can be influenced by an interaction with said recess (20) and/or said conductive coil (30).

8. The touch sensitive interface of claim 7, wherein said interaction causes a detectable interference and/or variation in said electromagnetic field (37).

9. The touch sensitive interface of claim 8, further comprising a detector (45) for detecting said interference and/or variation in said electromagnetic field (37).

10. The touch sensitive interface of claim 9, wherein said detector (45) either directly or indirectly interprets said interference and/or variation in said electromagnetic field (37) and/or actuates one or more associated operations in response thereto.

11. An interface cooperative with an upholstery or garment textile (65), comprising:
a textile construction (1); and
one or more conductive fibers (35) associated with said textile construction (1),
wherein said textile construction (1) has a three-dimensional recess (20) and said one or more conductive fibers (35) form a conductive coil (30).

12. The interface of claim 11, wherein said conductive coil (30) has an electromagnetic field (37) associated therewith.

13. The interface of claim 11, wherein at least some of said one or more conductive fibers (35) generate an electromagnetic field (37).

14. The interface of claim 12, wherein said electromagnetic field (37) can be influenced by an interaction with said recess (20) and/or said conductive coil (30).

15. The interface of claim 14, wherein said interaction causes a detectable interference and/or variation in said electromagnetic field (37).

16. The interface of claim 13, further comprising a detector (45) for either directly or indirectly detecting and/or interpreting said interference and/or variation in said electromagnetic field (37) to either directly or indirectly actuate one or more electronic operations or functions.

17. A method for forming a touch sensitive interface, comprising the steps of:
fashioning a three dimensional recess (20) either from or onto a textile construction (1); and
integrating one or more conductive fibers (35) into said three-dimensional recess (20) to form a conductive coil (30).

18. The method of claim 17, wherein said step of integrating one or more conductive fibers (35) into said three-dimensional recess (20) is accomplished during and/or after the step of fashioning said three dimensional recess (20).

19. The method of claim 17, further comprising the step of: heat molding said three-dimensional recess (20) and/or said one or more conductive fibers (35) to improve the strength and/or durability thereof.

20. The method of claim 17, further comprising the steps of:
patterning interface graphics (25) in and/or on said textile construction (1); and
integrating the touch sensitive interface into an upholstery or garment textile (65).
